(19) United States
(12) Patent Application Publication
(10) Pub. No.: US 2003/0006516 A1
(43) Pub. Date: Jan. 9, 2003

(54) Optical data storage medium containing a heterocyclic azo dye as the light-absorbing compound in the information layer

(76) Inventors: Horst Berneth, Leverkusen (DE); Friedrich-Karl Bruder, Krefeld (DE); Wilfried Haese, Odenthal (DE); Rainer Hagen, Leverkusen (DE); Karin Hassenruck, Dusseldorf (DE); Serguei Kostromine, Swisttal (DE); Peter Landenberger, Koln (DE); Rafael Oser, Krefeld (DE); Thomas Sommermann, Bergisch Gladbach (DE); Josef-Walter Stawitz, Odenthal (DE); Thomas Bieringer, Odenthal (DE)

Correspondence Address: BAYER CORPORATION, PATENT DEPARTMENT, 100 BAYER ROAD, PITTSBURGH, PA, 15205, US

(21) Appl. No.: 10/102,577

(22) Filed: Mar. 20, 2002

(30) Foreign Application Priority Data
Mar. 28, 2001 (DE) 10115227.2
Apr. 6, 2001 (DE) 10117461.6

(51) Int. Cl. B32B 3/02

(52) U.S. Cl. 264/1.33; 428/64.4

(57) ABSTRACT

An optical data storage medium containing a preferably transparent substrate which has optionally already been coated with one or more reflecting layers and onto the surface of which a photorecordable information layer, optionally one or more reflecting layers, and optionally a protective layer or an additional substrate or a top layer are applied, which data storage medium can be recorded on and read using blue or red light, preferably laser light, wherein the information layer contains a light-absorbing compound and optionally a binder, characterized in that at least one heterocyclic azo dye is used as the light-absorbing compound.

The invention relates to a preferably once recordable optical data storage medium containing a heterocyclic azo dye as the light-absorbing compound in the information layer, and to a process for its production.

Recordable optical data storage media using special light-absorbing substances or mixtures thereof are particularly suitable for use in high-density recordable optical data storage media which operate with blue laser diodes, and in particular GaN or SHG laser diodes (360-460 nm), and/or for use in DVD-R or CD-R discs, which operate with red (635-660 nm) or infrared (780-830 nm) laser diodes, and the application of the abovementioned dyes to a polymer substrate, in particular polycarbonate, by spin-coating or vapour deposition.

There has recently been an enormous growth in the sales of recordable compact discs (CD-R, 780 um), which represent the technically established system.

The next generation of optical data storage media—DVDs—is currently being introduced onto the market. By using shorter-wave laser radiation (635 to 660 nm) and a higher numerical aperture NA, the storage density can be increased. The recordable format is in this case the DVD-R.

Today, optical data storage formats which use blue laser diodes (based on GaN, JP 08191171 or Second Harmonic Generation SHG JP 09050629) (360 nm to 460 nm) with a high laser power, are being developed. Recordable optical data storage media will therefore also be used in this generation. The achievable storage density depends on the focussing of the laser spot in the information plane. The spot size is proportional to the laser wavelength λ/NA. NA is the numerical aperture of the objective lens used. The aim is to use the smallest possible wavelength λ for obtaining the highest possible storage density. Based on semiconductor laser diodes, 390 nm are presently possible.

The patent literature describes dye-based recordable optical data storage media which are equally suitable both for CD-R and DVD-R systems (JP-A 11 043 481 and JP-A 10 181 206). In order to obtain high reflectivity, a high modulation level of the readout signal and sufficient sensitivity during recording, use is made of the fact that the IR wavelength 780 nm of the CD-R is located at the base of the long-wavelength slope of the absorption peak of the dye and the red wavelength 635 nm or 650 nm of the DVD-R is located at the base of the short-wavelength slope of the absorption peak of the dye. In JP-A 02 557 335, JP-A 10 058 828, JP-A 06 336 086, JP-A 02 865 955, WO—A 09 917 284 and U.S. Pat. No. 5,266,699 this concept is extended to cover the working wavelength range of 450 nm on the short-wavelength slope and the red and IR range on the long-wavelength slope of the absorption peak.

In addition to the abovementioned optical properties, the recordable information layer consisting of light-absorbing organic substances must have a morphology which is as amorphous as possible, in order to keep the noise signal during recording or reading as small as possible. For this purpose it is particularly preferable, when applying the substances by spin-coating from a solution or by vapour deposition and/or sublimation, to prevent crystallization of the light-absorbing substances during the subsequent top-coating with metallic or dielectric layers in vacuo.

The amorphous layer of light-absorbing substances should preferably have high thermal stability, since otherwise additional layers of organic or inorganic material applied by sputtering or vapour deposition onto the light-absorbing information layer form blurred boundaries due to diffusion and thus have an adverse effect on the reflectivity. In addition, if a light-absorbing substance has inadequate thermal stability at the boundary to a polymeric substrate, it can diffuse into the latter and again have an adverse effect on the reflectivity.

If the light-absorbing substance has too high a vapour pressure, it can sublime during the abovementioned sputtering or vapour deposition of additional layers in a high vacuum and thus reduce the desired layer thickness. This in turn has a negative effect on reflectivity.

The object of the invention is therefore to provide suitable compounds which meet the high demands (such as light stability, a favourable signal-to-noise ratio, damage-free application to the substrate material, etc.) for use in the information layer of a recordable optical data storage medium, in particular for high-density recordable optical data storage formats in a laser wavelength range of 340 to 680 nm.

Surprisingly, it has been found that light-absorbing compounds from the group comprising heterocyclic azo dyes are particularly suitable for satisfying the abovementioned requirement profile.

The invention therefore relates to an optical data storage medium containing a preferably transparent substrate which has optionally already been coated with one or more reflecting layers and onto the surface of which a photorecordable information layer, optionally one or more reflecting layers and optionally a protective layer or an additional substrate or a top layer are applied, which data storage medium can be recorded on and read using blue or red light, preferably laser light, wherein the information layer contains a light-absorbing compound and optionally a binder, characterized in that at least one heterocyclic azo dye is used as the light-absorbing compound.

The light-absorbing compound should preferably be thermally modifiable. Preferably the thermal modification is carried out at a temperature of <600° C., particularly preferably at a temperature of <400° C., very particularly preferably at a temperature of <300° C., and in particular at a temperature of <200° C. Such a modification can for example be the decomposition or chemical modification of the chromophoric centre of the light-absorbing compound.

A heterocyclic azo dye of the formula

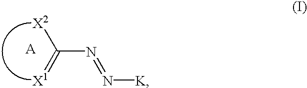

is preferred, in which

K represents the radical of a coupling component of the formula

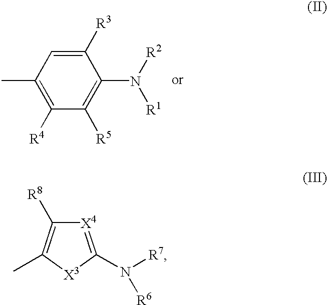

X¹ represents N or CH,

X² represenits O, S, N—R⁹ or CH, but X¹ and X² do not simultaneously represent CH,

A together with X1 and X² and the C-atom bound therebetween, represents a five- or six-membered aromatic or quasi-aromatic heterocyclic ring which contains 1 to 4 hetero atoms and/or can be benzo- or naphtho-fused and/or substituted by non-ionic radicals,

X³ represents O or S,

X⁴ represents CR¹⁰ or N,

R¹, R², R⁶, R⁷ and R⁹ independently of one another represent hydrogen, C₁- to C₆-alkyl, C₅- to C₇-cycloalkyl, C₆- to C₁₀-aryl or C₇- to C₁₅-aralkyl or

NR¹R² and NR⁶R⁷ independently of one another represent pyrrolidino, morpholino, piperazino or piperidino,

R³ and R⁵ independently of one another represent hydrogen, C₁- to C₆-alkyl, C₁- to C₆-alkoxy or halogen or

R³;R² and R⁵;R¹ independently of one another represent a two- or three-membered bridge which can contain O or N and can be substituted by non-ionic radicals,

R⁴ represents hydrogen, C₁- to C₆-alkyl, C₁- to C₆-alkoxy, halogen, C₁- to C₆-acylamino, C₁- to C₆-alkylsulphonylamino, C₆- to C₁₀-arylcarbonylamino or C₆-to C₁₀-arylsulphonylamino,

R⁸ represents hydrogen, C₁- to C₆-alkyl, halogen, C₆- to C₁₀-aryl, bis-C₁- to C₆-dialkylamino, pyrrolidino, piperidino or morpholino and

R¹⁰ represents hydrogen, cyano, C₁- to C₆-alkyl, halogen or C₆- to C₁₀-aryl.

Suitable non-ionic radicals are for example C₁- to C₄-alkyl, C₁- to C₄-alkoxy, halogen, cyano, nitro, C₁- to C₄-alkoxycarbonyl, C₁- to C₄-alkylthio, C₁- to C₄-alkanoylamino, benzoylamino and mono- or di-C₁- to C₄-alkylamino.

Alkyl, alkoxy, aryl and heterocyclic radicals can optionally contain other radicals such as alkyl, halogen, nitro, cyano, CO—NH₂, alkoxy, trialkylsilyl, trialkylsiloxy or phenyl, the alkyl and alkoxy radicals can be straight-chain or branched, the alkyl radicals can be partially halogenated or perhalogenated, the alkyl and alkoxy radicals can be ethoxylated or propoxylated or silylated, adjacent alkyl and/or alkoxy radicals on aryl or heterocyclic radicals can together form a three- or four-membered bridge and the heterocyclic radicals can be benzo-fused and/or quaternized.

Alkyl radicals, and in particular those having the meaning under R¹, R², R⁶ and R⁷, can also contain ionic radicals such as ammonium or COO— or SO₃— groups. Examples for such alkyl radicals are —CH₂—CH₂—N(CH₃)₃⁺ An⁻ or —CH₂—SO₃⁻ M⁺, wherein An⁻ represents an anion, such as for example tetrafluoroborate, and M⁺ represents a cation, such as for example tetramethylammonium.

Particularly preferably the radical of the formula

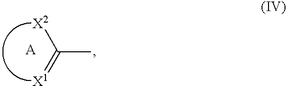

represents benzothiazol-2-yl, benzoxazol-2-yl, benzimidazol-2-yl, thiazol-2-yl, isothiazol-3-yl, isoxazol-3-yl, imidazol-2-yl, pyrazol-5-yl, 1,3,4-thiadiazol-2-yl, 1,2,4-thiadiazol-5-yl, 1,2,3-thiadiazol-5-yl, 1,3,4-oxadiazol-2-yl, 1,3,4-triazol-2-yl, thiophen-2-yl, benzothiophen-2-yl, 2- or 4-pyridyl or 2- or 4-quinolyl, it being possible for these radicals each to be substituted by C₁- to C₆-alkyl, C₁- to C₆-alkoxy, fluorine, chlorine, bromine, iodine, cyano, nitro, C₁- to C₆-alkoxycarbonyl, C₁- to C₆-alkylthio, C₁- to C₆-acylamino, C₆- to C₁₀-aryl, C₆- to C₁₀-aryloxy, C₆- to C₁₀-arylcarbonylamino, mono- or di-C₁- to C₆-alkylamino, N-C₁- to C₆-alkyl-N-C₆- to C₁₀-arylamino, pyrrolidino, piperidino, morpholino or piperazino.

In a very particularly preferred form the heterocyclic azo dyes used are those of the formula

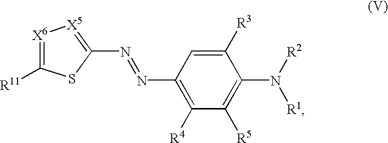

wherein

X⁵ and X⁶ independently of one another represent C—R¹² or N,

R¹¹ represents hydrogen, C₁- to C₄-alkyl, C₁- to C₄-alkoxy, C₅- to C₆-cycloalkoxy, C₆-to C₁₀-aryloxy, C₁- to C₄-alkylthio, mono- or bis-C₁- to C₄-alkylamino, N—C₁- to C₄-alkyl-N-C₆- to C₁₀-arylamino, N-C₁- to C₄-Alkyl-N-C₅- to C₆-cycloalkylamino, N—C₁- to C₄-alkyl-N-C₇- to C₁₂-aralkylamino, C₁- to C₄-alkanoylamino, C₆- to C₁₀-aroylamino, pyrrolidino, piperidino, piperazino or morpholino,

R¹² represents hydrogen, C₁- to C₄-alkyl, C₁- to C₄-alkoxy, cyano, C₁- to C₄-alkoxycarbonyl or C₆- to C₁₀-aryl, or if X⁶ represents C—R¹²,

R¹¹;R¹² together form a —CH═CH—CH═CH— bridge,

NR¹R² represents mono- or bis-C₁- to C₄-alkylamino, N-C₁- to C₄-alkyl-N-C₆- to C₁₀-arylamino, N-C₁- to C₄-alkyl-N-C₅- to C₆-cycloalkylamino, N-C₁- to C₄-alkyl-N-C₇- to C₁₂-aralkylamino, pyrrolidino, piperidino, piperazino or morpholino,

R³ represents hydrogen, C₁- to C₄-alkyl or C₁- to C₄-alkoxy or

R³; R¹ together represent a —CH₂—CH₂—, —CH₂—CH₂—CH₂—, —O—CH₂—CH₂— or —CH(CH₃)—CH₂—C(CH₃)₂- bridge,

R⁵ represents hydrogen or

R⁵; R² together represent a —CH₂—CH₂—, —CH₂—CH₂—CH₂—, —O—CH₂—CH₂— or —CH(CH₃)—CH₂—C(CH₃)₂— bridge and

R⁴ represents hydrogen, C₁- to C₄-alkyl, C₁- to C₄-alkoxy, chlorine, C₁- to C₄-alkanoylamino, N-C₁- to C₄-alkyl-N-C₁- to C₄-alkanoylamino, C₁- to C₄-alkylsulphonylamino, N-C₁- to C₄-alkyl-N-Ci- to C₄-alkylsulphonylamino, C₆- to C₁₀-aroylamino or C₆- to C₁₀-arylsulphonylamino.

In a form which is also very particularly preferred the heterocyclic azo dyes used are those of the formula

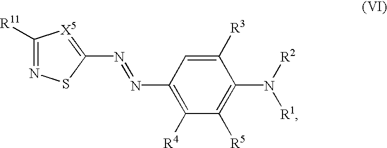

wherein

X⁵ represents C—R¹² or N,

R¹¹ represents hydrogen, C₁- to C₄-alkyl, C₁- to C₄-alkoxy, C₅- to C₆-cycloalkoxy, C₆- to C₁₀-aryloxy, C₁- to C₄-alkylthio, mono- or bis-C₁- to C₄-alkylamino, N-C₁- to C₄-alkyl-N-C₆- to C₁₀-arylamino, N-C₁- to C₄-alkyl-N-C₅- to C₆-cycloalkylamino, N-C₁- to C₄-alkyl-N-C₇- to C₁₂-aralkylamino, C₁- to C₄-alkanoylamino, C₆- to C₁₀-aroylamino, pyrrolidino, piperidino, piperazino or morpholino,

R¹² represents hydrogen, C₁- to C₄-alkyl, C₁- to C₄-alkoxy, cyano, nitro, C₁- to C₄-alkoxycarbonyl or C₆- to C₁₀-aryl, or if X⁵ represents C—R¹²,

R¹;R¹² together form a —CH═CH—CH═CH— bridge,

NR¹R² represents mono- or bis-C₁- to C₄-alkylamino, N-C₁- to C₄-alkyl-N-C₆- to C₁₀-arylamino, N-C₁- to C₄-alkyl-N-C₅- to C₆-cycloalkylamino, N-C₁- to C₄-alkyl-N-C₇- to C₁₂-aralkylamino, pyrrolidino, piperidino, piperazino or morpholino,

R³ represents hydrogen, C₁- to C₄-alkyl or C₁- to C₄-alkoxy or

R³; R¹ together represent a —CH₂—CH₂—, —CH₂—CH₂—CH₂—, —O—CH₂—CH₂— or —CH(CH₃)—CH₂—C(CH₃)₂— bridge,

R⁵ represents hydrogen or

R⁵; R² together represent a —CH₂—CH₂—, —CH₂—CH₂—CH₂—, —O—CH₂—CH₂— or —CH(CH₃)—CH₂—C(CH₃)₂— bridge and

R⁴ represents hydrogen, C₁- to C₄-alkyl, C₁- to C₄-alkoxy, chlorine, C₁- to C₄-alkanoylamino, N-C₁- to C₄-alkyl-N-C₁- to C₄-alkanoylamino, C₁- to C₄-alkylsulphonylamino, N—C,- to C₄-alkyl-N-C₁- to C₄-alkylsulphonylamino, C₆- to C₁₀-aroylamino or C₆- to C₁₀-arylsulphonylamino.

In a form which is also very particularly preferred the heterocyclic azo dyes used are those of the formula

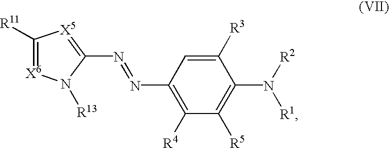

in which

X⁵ and X⁶ independently of one another represent C—R¹² or N,

R¹¹ represents hydrogen, C₁- to C₄-alkyl, C₁- to C₄-alkoxy, C₅- to C₆-cycloalkoxy, C₆- to C₁₀-aryloxy, C₁- to C₄-alkylthio, mono- or bis-C₁- to C₄-alkylamino, N-C₁- to C₄-alkyl-N-C₆- to C₁₀-arylamino, N-C₁- to C₄-alkyl-N-C₅- to C₆-cycloalkylamino, N-C₁- to C₄-alkyl-N-C₇- to C₁₂-aralkylamino, C₁- to C₄-alkanoylamino, C₆- to C₁₀-aroylamino, pyrrolidino, piperidino, piperazino or morpholino,

R¹² represents hydrogen, C₁- to C₄-alkyl, C₁- to C₄-alkoxy, cyano, C₁- to C₄-alkoxycarbonyl or C₆- to C₁₀-aryl or if X⁶ represents C—R¹²,

R¹¹;R¹² together form a —CH═CH—CH═CH— bridge,

R¹³ represents hydrogen, C₁- to C₄-alkyl, C₅- to C₆-cycloalkyl, C₇ to C₁₂-aralkyl or C₆- to C₁₀-aryl,

NR¹R² represents mono- or bis-C₁- to C₄-alkylamino, N-C₁- to C₄-alkyl-N-C₆- to C₁₀-arylamino, N-C₁- to C₄-alkyl-N-C₅- to C₆-cycloalkylamino, N-C₁- to C₄-alkyl-N-C₇- to C₁₂-aralkylamino, pyrrolidino, piperidino, piperazino or morpholino,

R³ represents hydrogen, C₁-to C₄-alkyl or C₁- to C₄-alkoxy or

R³; R¹ together represent a —CH₂—CH₂—, —CH₂—CH₂—CH₂—, —O—CH₂—CH₂— or —CH(CH₃)—CH₂—C(CH₃)₂— bridge,

R⁵ represents hydrogen or

R⁵; R² together represent a —CH₂—CH₂—, —CH₂—CH₂—CH₂—, —O—CH₂—CH₂— or —CH(CH₃)—CH₂—C(CH₃)₂— bridge and

R⁴ represents hydrogen, C₁- to C₄-alkyl, C₁- to C₄-alkoxy, chlorine, C₁- to C₄-alkanoylamino, N-C₁- to C₄-alkyl-N-C₁- to C₄-alkanoylamino, C₁- to C₄-alkylsulphonylamino, N-C₁- to C₄-alkyl-N-C₁- to C₄-alkylsulphonylamino, C₆- to C₁₀-aroylamino or C₆- to C₁₀-arylsulphonylamino.

In a form also very particularly preferred the heterocyclic azo dyes used are those of the formula

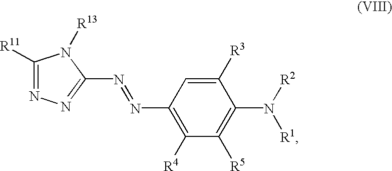

in which

R¹¹ represents hydrogen, C₁- to C₄-alkyl, C₁- to C₄-alkoxy, C₅- to C₆-cycloalkoxy, C₆- to C₁₀-aryloxy, C₁- to C₄-alkylthio, mono- or bis-C₁- to C₄-alkylamino, N-C₁- to C₄-alkyl-N-C₆- to C₁₀-arylamino, N-C₁- to C₄-alkyl-N-C₅- to C₆-cycloalkylamino, N-C₁- to C₄-alkyl-N-C₇- to C₁₂-aralkylamino, C₁- to C₄-alkanoylamino, C₆- to C₁₀-aroylamino, pyrrolidino, piperidino, piperazino or morpholino,

R¹³ represents hydrogen, C₁- to C₄-alkyl, C₅- to C₆-cycloalkyl, C₇ to C₁₂-aralkyl or C₆- to C₁₀-aryl,

NR¹R² represents mono- or bis-C₁- to C₄-alkylamino, N-C₁- to C₄-alkyl-N-C₆- to C₁₀-arylamino, N-C₁- to C₄-alkyl-N-Cs- to C₆-cycloalkylamino, N-C₁- to C₄-alkyl-N-C₇- to C₁₂-aralkylamino, pyrrolidino, piperidino, piperazino or morpholino,

R³ represents hydrogen, C₁- to C₄-alkyl or C₁- to C₄-alkoxy or

R³; R¹ together represent a —CH₂—CH₂—, —CH₂—CH₂—CH₂—, —O—CH₂—CH₂— or —CH(CH₃)—CH₂—C(CH₃)₂— bridge,

R⁵ represents hydrogen or

R⁵; R² together represent a —CH₂—CH₂—, —CH₂—CH₂—CH₂—, —O—CH₂—CH₂— or —CH(CH₃)—CH₂—C(CH₃)₂— bridge and

R⁴ represents hydrogen, C₁- to C₄-alkyl, C₁- to C₄-alkoxy, chlorine, C₁- to C₄-alkanoylamino, N-C₁- to C₄-alkyl-N-C₁- to C₄-alkanoylamino, C₁- to C₄-alkylsulphonylamino, N-C₁- to C₄-alkyl-N-C₁- to C₄-alkylsulphonylamino, C₆- to C₁₀-aroylamino or C₆- to C₁₀-arylsulphonylamino.

In a form which is also very particularly preferred the heterocyclic azo dyes used are those of the formula

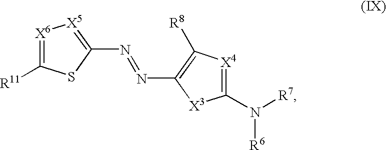

in which

X⁵ and X⁶ independently of one another represent C—R¹² or N,

R¹¹ represents hydrogen, C₁- to C₄-alkyl, C₁- to C₄-alkoxy, C₅- to C₆-cycloalkoxy, C₆- to C₁₀-aryloxy, C₁- to C₄-alkylthio, mono- or bis-C₁- to C₄-alkylamino, N—C₁- to C₄-alkyl-N-C₆- to C₁₀-arylamino, N-C₁- to C₄-alkyl-N-C₅- to C₆-cycloalkylamino, N-C₁- to C₄-alkyl-N-C₇- to C₁₂-aralkylamino, C₁- to C₄-alkanoylamino, C₆- to C₁₀-aroylamino, pyrrolidino, piperidino, piperazino or morpholino,

R¹² represents hydrogen, C₁- to C₄-alkyl, C₁- to C₄-alkoxy, cyano, C₁- to C₄-alkoxycarbonyl or C₆- to C₁₀-aryl or, X⁶represents C—R¹²,

R¹¹;R¹² together form a —CH═CH—CH═CH— bridge,

X³ represents O or S,

X⁴ represents CH or N,

NR⁶R⁷ represents mono- or bis-C₁- to C₄-alkylamino, N-C₁- to C₄-alkyl-N-C₆- to C₁₀-arylamino, N-C₁- to C₄-alkyl-N-C₅- to C₆-cycloalkylamino, N-C₁- to C₄-alkyl-N-C₇- to C₁₂-aralkylamino, pyrrolidino, piperidino, piperazino or morpholino,

R⁸ represents hydrogen, C₁- to C₄-alkyl, chlorine, C₆- to C₁₀-aryl, bis-C₁- to C₄-dialkylamino, pyrrolidino, piperidino or morpholino.

In a form which is also very particularly preferred the heterocyclic azo dyes used are those of the formula

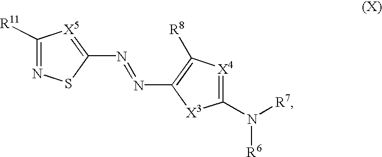

in which

X⁵ represents C—R¹² or N,

R¹¹ represents hydrogen, C₁- to C₄-alkyl, C₁- to C₄-alkoxy, C₅- to C6-cycloalkoxy, C₆- to C₁₀-aryloxy, C₁- to C₄-alkylthio, mono- or bis-C₁- to C₄-alkylamino, N-C₁- to C₄-alkyl-N-C₆- to C₁₀-arylamino, N-C₁- to C₄-alkyl-N-C₅- to C₆-cycloalkylamino, N-C₁- to C₄-alkyl-N-C₇- to C₁₂-aralkylamino, C₁- to C₄-alkanoylamino, C₆- to C₁₀-aroylamino, pyrrolidino, piperidino, piperazino or morpholino,

R¹² represents hydrogen, C₁- to C₄-alkyl, C₁- to C₄-alkoxy, cyano, nitro, C₁- to C₄-alkoxycarbonyl or C₆-to C₁₀-aryl, or, if X⁵ represents C—R¹²,

R¹¹;R¹² together form a —CH═CH—CH═CH— bridge,

X³ represents O or S,

X⁴ represents CH or N,

NR⁶R⁷ represents mono- or bis-C₁- to C₄-alkylamino, N—C₁- to C₄-alkyl-N-C₆- to C₁₀-arylamino, N-C₁- to C₄-alkyl-N-C₅- to C₆-cycloalkylamino, N-C₁- to C₄-alkyl-N-C₇- to C₁₂-aralkylamino, pyrrolidino, piperidino, piperazino or morpholino,

R⁸ represents hydrogen, C₁- to C₄-alkyl, chlorine, C₆- to C₁₀-aryl, bis-C₁- to C₄-dialkylamino, pyrrolidino, piperidino or morpholino.

In a form which is also very particularly preferred the heterocyclic azo dyes used are those of the formua

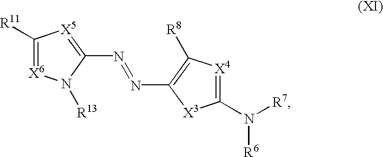

in which

X⁵ and X⁶ independently of one another represent C—RK² or N,

R¹¹ represents hydrogen, C₁- to C₄-alkyl, C₁- to C₄-alkoxy, C₅- to C₆-cycloalkoxy, C₆- to C₁₀-aryloxy, C₁- to C₄-alkylthio, mono- or bis-C₁- to C₄-alkylamino, N-C₁- to C₄-alkyl-N-C₆- to C₁₀-arylamino, N-C₁- to C₄-alkyl-N-C₅- to C₆-cycloalkylamino, N-C₁- to C₄-alkyl-N-C₇- to C₁₂-aralkylamino, C₁- to C₄-alkanoylamino, C₆- to C₁₀-aroylamino, pyrrolidino, piperidino, piperazino or morpholino,

R¹² represents hydrogen, C₁- to C₄-alkyl, C₁- to C₄-alkoxy, cyano, C₁- to C₄-alkoxycarbonyl or C₆- to C₁₀-aryl, or, if X⁶ represents C—RK2 or, if X⁵ represents C—R¹²,

R¹¹;R¹² together form a —CH═CH—CH═CH— bridge,

R³ represents hydrogen, C₁- to C₄-alkyl, C₅- to C₆-cycloalkyl, C₇- to C₁₂-aralkyl or C₆- to C₁₀-aryl,

X³ represents O or S,

X⁴ represents CH or N,

NR⁶R⁷ represents mono- or bis-C1- to C₄-alkylamino, N-C₁- to C₄-alkyl-N-C₆- to C₁₀-arylamino, N-C₁- to C₄-alkyl-N-C₅- to C₆-cycloalkylamino, N-C₁- to C₄-alkyl-N-C₇- to C₁₂-aralkylamino, pyrrolidino, piperidino, piperazino or morpholino and

R⁸ represents hydrogen, C₁- to C₄-alkyl, chlorine, C₆- to C₁₀-aryl, bis-C₁- to C₄-dialkylamino, pyrrolidino, piperidino or morpholino.

In a form which is also very particularly preferred the heterocyclic azo dyes used are those of the formula

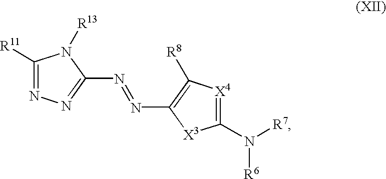

in which

R¹¹ represents hydrogen, C₁- to C₄-alkyl, C₁- to C₄-alkoxy, Cs- to C₆-cycloalkoxy, C₆- to C₁₀-aryloxy, C₁- to C₄-alkylthio, mono- or bis-C₁- to C₄-alkylamino, N-C₁- to C₄-alkyl-N-C₆- to C₁₀-arylamino, N-C₁- to C₄-alkyl-N-C₄- to C₆-cycloalkylamino, N-C₁- to C₄-alkyl-N-C₇- to C₁₂-aralkylamino, C₁- to C₄-alkanoylamino, C₆- to C₁₀-aroylamino, pyrrolidino, piperidino, piperazino or morpholino,

R¹³ represents hydrogen, C₁- to C₄-alkyl, C₅- to C₆-cycloalkyl, C₇- to C₁₂-aralkyl or C₆- to C₁₀-aryl,

X³ represents O or S,

X⁴ represents CH or N,

NR⁶R⁷ represents mono- or bis-C₁- to C₄-alkylamino, N-C₁- to C₄-alkyl-N-C₆- to C₁₀-arylamino, N-C₁- to C₄-alkyl-N-C₅- to C₆-cycloalkylamino, N-C₁- to C₄-alkyl-N-C₇- to C₁₂-aralkylamino, pyrrolidino, piperidino, piperazino or morpholino,

R⁸ represents hydrogen, C₁- to C₄-alkyl, chlorine, C₆- to C₁₀-aryl, bis-C₁- to C₄-dialkylamino, pyrrolidino, piperidino or morpholino.

For a recordable optical data storage medium according to the invention which is recorded on and read using light from a blue laser, such heterocyclic azo dyes are preferred whose absorption maximum λₘₐₓ₂ is in the range from 420 to 550 nm, wherein the wavelength λ_{1/2} at which the extinction on the short-wavelength slope of the absorption maximum of the wavelength λₘₐₓ₂ is half the extinction value at λₘₐₓ₂, and the wavelength λ_{1/10}, at which the extinction on the short-wavelength slope of the absorption maximum of the wavelength λₘₐₓ₂ is a tenth of the extinction value at λₘₐₓ₂, are preferably in each case no further than 80 nm away from each other.

Preferably such a heterocyclic azo dye does not display a shorter-wave maximum λₘₐₓ₁ at a wavelength below 350 nm, particularly preferably below 320 nm, and very particularly preferably below 290 nm.

Preferred heterocyclic azo dyes are those with an absorption maximum λₘₐₓ₂ of 430 to 550 nm, in particular 440 to 530 inm, and very particularly preferably 450 to 520 nm.

In these heterocyclic azo dyes λ_{1/2} and λ_{1/10} , as defined above, are preferably no further than 70 um, particularly preferably no further than 50 nm, and very particularly preferably no further than 40 nm away from each other.

For a recordable optical data storage medium according to the invention which is recorded on and read using light from a red laser, such heterocyclic azo dyes are preferred whose absorption maximum λₘₐₓ₂ is in the range from 500 to 650 nm, wherein the wavelength λ_{1/2} at which the extinction on the long-wavelength slope of the absorption maximum of the wavelength λₘₐₓ₂ is half the extinction value at λₘₐₓ₂, and the wavelength λ_{1/10}, at which the extinction on the long-wavelength slope of the absorption maximum of the wavelength λₘₐₓ₂ is a tenth of the extinction value at λₘₐₓ₂, are preferably in each case no further than 60 nm away from each other. Preferably such a heterocyclic azo dye does not display a longer-wave maximum λₘₐₓ₃ at a wavelengh below 750 nm, particularly preferably below 800 nm, and very particularly preferably below 850 nm.

Preferred heterocyclic azo dyes are those with an absorption maximum λₘₐₓ₂ of 510 to 620 nm.

Particularly preferred heterocyclic azo dyes are those with an absorption maximum λₘₐₓ₂ of 530 to 610 nm.

Very particularly preferred heterocyclic azo dyes are those with an absorption maximum λₘₐₓ₂ of 550 to 600 nm.

In these heterocyclic azo dyes λ_{1/2} and λ_{1/10}, as defined above, are preferably no further than 50 nm, particularly preferably no further than 40 um, and very particularly preferably no further than 30 nm away from each other.

At the absorption maximum λₘₐₓ₂ the heterocyclic azo dyes preferably have a molar extinction coefficient E of >25000 l/mol cm, preferably >35000 l/mol cm, particularly preferably >40000 l/mol cm and very particularly preferably >50000 l/mol cm.

The absorption spectra are, for example, measured in solution.

Suitable heterocyclic azo dyes having the required spectral properties are in particular those in which the change in the dipole moment Δμ=|μ_{g}−μ_{ag}|, i.e. the positive difference between the dipole moments in the ground state and the first excited state is as small as possible, i.e. preferably <5 D, and particularly preferably <2 D. One method of determining such a change in the dipole moment Δμ is described for example in F. Würthner et al., Angew. Chem. 1997, 109, 2933 and in the literature cited therein. Low solvatochromism (dioxan/DMF) is also a suitable criterion for selection. Preferred heterocyclic azo dyes are those whose solvatochromism Δλ=|λ_{DMF}λ_{dioxan}|, i.e. the positive difference between the absorption wavelengths in the solvents dimethyl formamide and dioxan is <20 nm, particularly preferably <10 nm, and very particularly preferably <5 nm.

Very particularly preferred heterocyclic azo dyes according to the invention are those of the formula

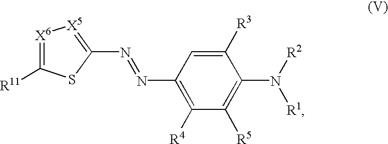

in which

X⁵ and X⁶ represent N,

R¹¹ represents hydrogen, methyl, ethyl, propyl, butyl, methoxy, ethoxy, phenoxy, methylthio, ethylthio, propylthio, butylthio, dimethylamino, diethylamino, dipropylamino, dibutylamino, N-methyl-N-cyanoethylamino, N-methyl-N-methoxyethylamino, N-methyl-N-hydroxyethylamino, bis-(cyanoethyl)-amino, bis-(methoxyethyl)amino, bis-(hydroxyethyl)amino, N-methyl-N-benzylamino, N-methyl-N-phenylamino, phenylamino, methoxyphenylamino, pyrrolidino, piperidino, N-methyl-, N-ethyl-, N-hydroxyethyl- or N-cyanoethylpiperazino or morpholino,

NR¹R² represents dimethylamino, diethylamino, dipropylamino, dibutylamino, N-methyl-N-cyanoethylamino, N-methyl-N-methoxyethylamino, N-methyl-N-hydroxyethylamino, bis-(cyanoethyl)amino, bis-(methoxyethyl)amino, bis-(hydroxyethyl)amino, N-methyl-N-benzylamino, N-methyl-N-phenylamino, phenylamino, methoxyphenylamino, pyrrolidino, piperidino, N-methyl-, N-ethyl-, N-hydroxyethyl- or N-cyanoethylpiperazino or morpholino,

R³ represents hydrogen, methyl or methoxy or

R³; R¹ together represent a —CH₂—CH₂—, —CH₂—CH₂—CH₂—, —O—CH₂—CH₂— or —CH(CH₃)—CH₂—C(CH₃)₂— bridge,

R⁵ represents hydrogen and

R⁴ represents hydrogen, methyl, ethyl, methoxy, ethoxy, chlorine, formylamino, acetylamino, trifluoroacetylamino, propionylamino, butanoylamino, N-methyl-N-acetylamino, methanesulphonylamino, ethanesulphonylamino, trifluoromethanesulphonylamino, N-methyl-N-methanesulphonylamino, benzoylamino or benzenesulphonylamino,

it being possible for the alkyl radicals such as propyl, butyl etc. to be branched.

Heterocyclic azo dyes which are also very particularly suitable according to the invention are those of the formula

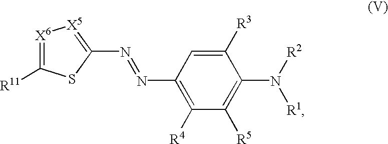

in which

X⁵ represents C—R¹²,

X⁶ represents C—R^{12′},

R¹¹ and R¹² independently of one another represent hydrogen, methyl, ethyl, cyano, chlorine, nitro, methoxycarbonyl or ethoxycarbonyl,

R^{12′} represents hydrogen, methyl or ethyl,

NR¹R² represents dimethylamino, diethylamino, dipropylamino, dibutylamino, N-methyl-N-cyanoethylamino, N-methyl-N-methoxyethylamino, N-methyl-N-hydroxyethylamino, bis-(cyanoethyl)amino, bis-(methoxyethyl)amino, bis-(hydroxyethyl)amino, N-methyl-N-benzylamino, N-methyl-N-phenylamino, phenylamino, methoxyphenylamino, pyrrolidino, piperidino, N-methyl-, N-ethyl-, N-hydroxyethyl- or N-cyanoethylpiperazino or morpholino,

R³ represents hydrogen, methyl or methoxy or

R³; R¹ together represent a —CH₂—CH₂—, —CH₂—CH₂—CH₂—, —O—CH₂—CH₂— or —CH(CH₃)—CH₂—C(CH₃)₂— bridge,

R⁵ represents hydrogen and

R⁴ represents hydrogen, methyl, ethyl, methoxy, ethoxy, chlorine, formylamino, acetylamino, trifluoroacetylamino, propionylamino, butanoylamino, N-methyl-N-acetylamino, methanesulphonylamino, ethanesulphonylamino, trifluoromethanesulphonylamino, N-methyl-N-methanesulphonylamino, benzoylamino or benzenesulfonylamino,

wherein the alkyl radicals such as propyl, butyl, etc. can be branched.

Heterocyclic azo dyes which are also very particularly suitable according to the invention are those of the formula

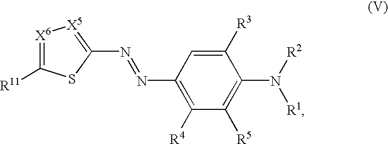

in which

X⁵ represents N.

X⁶represents C—R¹²,

R¹¹ represents hydrogen, methyl, ethyl, propyl, butyl, methoxy, ethoxy, phenoxy, methylthio, ethylthio, propylthio, butylthio, dimethylamino, diethylamino, dipropylamino, dibutylamino, N-methyl-N-cyanoethylamino, N-methyl-N-methoxyethylamino, N-methyl-N-hydroxyethylamino, bis-(cyanoethyl)amino, bis-(methoxyethyl)amino, bis-(hydroxyethyl)amino, N-methyl-N-benzylamino, N-methyl-N-phenylamino, phenylamino, methoxyphenylamino, pyrrolidino, piperidino, N-methyl-, N-ethyl-, N-hydroxyethyl- or N-cyanoethylpiperazino or morpholino,

R¹² represents hydrogen, methyl or ethyl or

R¹¹;R¹² together represent a —CH═CH—CH═CH— bridge which can be substituted by methyl, chlorine, nitro or methoxy,

NR¹R² represents dimethylamino, diethylamino, dipropylamino, dibutylamino, N-methyl-N-cyanoethylamino, N-methyl-N-methoxyethylamino, N-methyl-N-hydroxyethylamino, bis-(cyanoethyl)amino, bis-(methoxyethyl)amino, bis-(hydroxyethyl)amino, N-methyl-N-benzylamino, N-methyl-N-phenylamino, phenylamino, methoxyphenylamino, pyrrolidino, piperidino, N-methyl-, N-ethyl-, N-hydroxyethyl- or N-cyanoethylpiperazino or morpholino,

R³ represents hydrogen, methyl or methoxy or

R³; R¹ together represent a —CH₂—CH₂—, —CH₂—CH₂—CH₂—, —O—CH₂—CH₂— or —CH(CH₃)—CH₂—C(CH₃)₂— bridge,

R⁵ represents hydrogen and

R⁴ represents hydrogen, methyl, ethyl, methoxy, ethoxy, chlorine, formylamino, acetylamino, trifluoroacetylamino, propionylamino, butanoylamino, N-methyl-N-acetylamino, methanesulphonylamino, ethanesulphonylamino, trifluoromethanesulphonylamino, N-methyl-N-methanesulphonylamino, benzoylamino or benzenesulphonylamino,

wherein the alkyl radicals such as propyl, butyl etc. can be branched.

Heterocyclic azo dyes which are also particularly suitable according to the invention are those of the formula

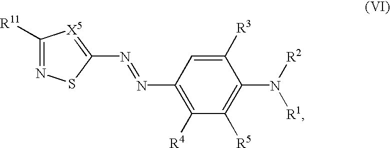

in which

X⁵ represents N,

R¹¹ represents hydrogen, methyl, ethyl or phenyl,

NR¹R² represents dimethylamino, diethylamino, dipropylamino, dibutylamino, N-methyl-N-cyanoethylamino, N-methyl-N-methoxyethylamino, N-methyl-N-hydroxyethylamino, bis-(cyanoethyl)amino, bis-(methoxyethyl)amino, bis-(hydroxyethyl)amino, N-methyl-N-benzylamino, N-methyl-N-phenylamino, phenylamino, methoxyphenylamino, pyrrolidino, piperidino, N-methyl-, N-ethyl-, N-hydroxyethyl- or N-cyanoethylpiperazino or morpholino,

R³ represents hydrogen, methyl or methoxy or

R³; R¹ together represent a —CH₂—CH₂—, —CH₂—C₂—CHCH₂—, —O—CH₂—CH₂— or —CH(CH₃)—CH₂—C(CH₃)₂— bridge,

R⁵ represents hydrogen and

R⁴ represents hydrogen, methyl, ethyl, methoxy, ethoxy, chlorine, formylamino, acetylamino, trifluoroacetylamino, propionylamino, butanoylamino, N-methyl-N-acetylamino, methanesulphonylamino, ethanesulphonylamino, trifluoromethanesulphonylamino, N-methyl-N-methanesulphonylamino, benzoylamino or benzenesulphonylamino,

wherein the alkyl radicals such as propyl, butyl etc. can be branched.

Heterocyclic azo dyes which are also very particularly suitable according to the invention are those of the formula

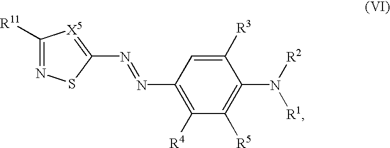

in which

X⁵ represents C—R¹²,

R¹¹ represents hydrogen, methyl, ethyl or phenyl,

R¹² represents hydrogen, cyano, nitro, methoxycarbonyl or ethoxycarbonyl or

R¹¹;R¹² together represent a —CH═CH—CH═CH— bridge, which can be substituted by methyl, methoxy, chlorine, cyano, nitro, methoxycarbonyl or ethoxycarbonyl,

NR¹R²represents dimethylamino, diethylamino, dipropylamino, dibutylamino, N-methyl-N-cyanoethylamino, N-methyl-N-methoxyethylamino, N-methyl-N-hydroxyethylamino, bis-(cyanoethyl)amino, bis-(methoxyethyl)amino, bis-(hydroxyethyl)amino, N-methyl-N-benzylamino, N-methyl-N-phenylamino, phenylamino, methoxyphenylamino, pyrrolidino, piperidino, N-methyl-, N-ethyl-, N-hydroxyethyl- or N-cyanoethylpiperazino or morpholino,

R³ represents hydrogen, methyl or methoxy or

R³; R¹ together represent a —CH₂—CH₂—, —CH₂—CH₂—CH₂—, —O—CH₂—CH₂— or —CH(CH₃)—CH₂—C(CH₃)₂— bridge,

R⁵ represents hydrogen and

R⁴ represents hydrogen, methyl, ethyl, methoxy, ethoxy, chlorine, formylamino, acetylamino, trifluoroacetylamino, propionylamino, butanoylamino, N-methyl-N-acetylamino, methanesulphonylamino, ethanesulphonylamino, trifluoromethanesulphonylamino, N-methyl-N-methanesulphonylamino, benzoylamino or benzenesulphonylamino,

wherein the alkyl radicals such as propyl, butyl, etc. can be branched.

Heterocyclic azo dyes which are also very particularly suitable according to the invention are those of the formula

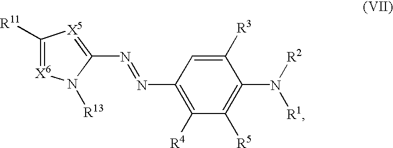

in which

X⁵ represents N,

X⁶ represents C—R¹²,

R¹¹ represents hydrogen, methyl, ethyl, methoxy, ethoxy, methylthio, amino, dimethylamino, diethylamino, formylamino, acetylamino, benzoylamino, pyrrolidino, piperidino, N-methyl-, N-ethyl-, N-hydroxyethyl- or N-cyanoethylpiperazino or morpholino,

R¹² represents hydrogen, methyl, ethyl, cyano, methoxycarbonyl, ethoxycarbonyl or phenyl steht,

R¹³ represents hydrogen, methyl, ethyl, propyl, butyl, cyclohexyl, benzyl or phenyl,

NR¹R² represents dimethylamino, diethylamino, dipropylamino, dibutylamino, N-methyl-N-cyanoethylamino, N-methyl-N-methoxyethylamino, N-methyl-N-hydroxyethylamino, bis-(cyanoethyl)amino, bis-(methoxyethyl)amino, bis-(hydroxyethyl)amino, N-methyl-N-benzylamino, N-methyl-N-phenylamino, phenylamino, methoxyphenylamino, pyrrolidino, piperidino, N-methyl-, N-ethyl-, N-hydroxyethyl- or N-cyanoethylpiperazino or morpholino,

R³ represents hydrogen, methyl or methoxy or

R³; R¹ together represent a —CH₂—CH₂—, —CH₂—CH₂—CH₂—, —O—CH₂—CH₂— or —CH(CH₃)—CH₂—C(CH₃)₂— bridge,

R⁵ represents hydrogen and

R⁴ represents hydrogen, methyl, ethyl, methoxy, ethoxy, chlorine, formylamino, acetylamino, trifluoroacetylamino, propionylamino, butanoylamino, N-methyl-N-acetylamino, methanesulphonylamino, ethanesulphonylamino, trifluoromethanesulphonylamino, N-methyl-N-methanesulphonylamino, benzoylamino or benzenesulphonylamino,

wherein the alkyl radicals such as propyl, butyl, etc. can be branched.

Heterocyclic azo dyes which are also very particularly suitable according to the invention are those of the formula

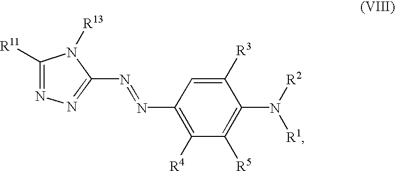

in which

R¹¹ represents hydrogen, methyl, ethyl, methoxy, phenyl, amino, dimethylamino, acetylamino, pyrrolidino, piperidino, N-methyl-, N-ethyl-, N-hydroxyethyl- or N-cyanoethylpiperazino or morpholino,

R¹³ represents hydrogen, methyl, ethyl, propyl, butyl, cyclohexyl, benzyl or phenyl,

NR¹R²represents dimethylamino, diethylamino, dipropylamino, dibutylamino, N-methyl-N-cyanoethylamino, N-methyl-N-methoxyethylamino, N-methyl-N-hydroxyethylamino, bis-(cyanoethyl)amino, bis-(methoxyethyl)amino, bis-(hydroxyethyl)amino, N-methyl-N-benzylamino, N-methyl-N-phenylamino, phenylamino, methoxyphenylamino, pyrrolidino, piperidino, N-methyl-, N-ethyl-, N-hydroxyethyl- or N-cyanoethylpiperazino or morpholino,

R³ represents hydrogen, methyl or methoxy or

R³; R¹ together represent a —CH₂—CH₂—, —CH₂—CH₂—CH₂—, —O—CH₂—CH₂— or —CH(CH₃)—CH₂—C(CH₃)₂— bridge,

R⁵ represents hydrogen and

R⁴ represents hydrogen, methyl, ethyl, methoxy, ethoxy, chlorine, formylamino, acetylamino, trifluoroacetylamino, propionylamino, butanoylamino, N-methyl-N-acetylamino, methanesulphonylamino, ethanesulphonylamino, trifluoromethanesulphonylamino, N-methyl-N-methanesulphonylamino, benzoylamino or benzenesulphonylamino,

wherein the alkyl radicals such as propyl, butyl, etc. can be branched.

Heterocyclic azo dyes which are also very particularly suitable according to the invention are those of the formula

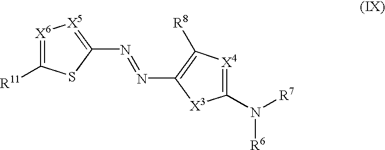

in which

X⁵ and X⁶ represent N,

R¹¹ represents hydrogen, methyl, ethyl, propyl, butyl, methoxy, ethoxy, phenoxy, methylthio, ethylthio, propylthio, butylthio, dimethylamino, diethylamino, dipropylamino, dibutylamino, N-methyl-N-cyanoethylamino, N-methyl-N-methoxyethylamino, N-methyl-N-hydroxyethylamino, bis-(cyanoethyl)amino, bis-(methoxyethyl)amino, bis-(hydroxyethyl)amino, N-methyl-N-benzylamino, N-methyl-N-phenylamino, phenylamino, methoxyphenylamino, pyrrolidino, piperidino, N-methyl-, N-ethyl-, N-hydroxyethyl- or N-cyanoethylpiperazino or morpholino,

X³ represents O or S,

X⁴ represents N or CH,

NR⁶R⁷represents dimethylamino, diethylamino, dipropylamino, dibutylamino, N-methyl-N-cyanoethylamino, N-methyl-N-methoxyethylamino, N-methyl-N-hydroxyethylamino, bis-(cyanoethyl)amino, bis-(methoxyethyl)amino, bis-(hydroxyethyl)amino, N-methyl-N-benzylamino, N-methyl-N-phenylamino, phenylamino, methoxyphenylamino, pyrrolidino, piperidino, N-methyl-, N-ethyl-, N-hydroxyethyl- or N-cyanoethylpiperazino or morpholino, and

R⁸ represents hydrogen, methyl, ethyl, chlorine or phenyl,

wherein the alkyl radicals such as propyl, butyl, etc. can be branched.

Heterocyclic azo dyes which are also very particularly suitable according to the invention are those of the formula

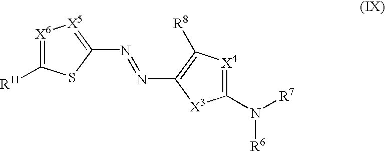

in which

X⁵ represents C—R¹²,

X⁶ represents C—R^{12′},

R¹¹ and R¹² independently of one another represent hydrogen, methyl, ethyl, cyano, chlorine, nitro, methoxycarbonyl or ethoxycarbonyl,

R^{12′} represents hydrogen, methyl or ethyl,

X³ represents O or S,

X⁴ represents N or CH,

NR⁶R⁷ represents dimethylamino, diethylamino, dipropylamino, dibutylamino, N-methyl-N-cyanoethylamino, N-methyl-N-methoxyethylamino, N-methyl-N-hydroxyethylamino, bis-(cyanoethyl)amino, bis-(methoxyethyl)amino, bis-(hydroxyethyl)amino, N-methyl-N-benzylamino, N-methyl-N-phenylamino, phenylamino, methoxyphenylamino, pyrrolidino, piperidino, N-methyl-, N-ethyl-, N-hydroxyethyl- or N-cyanoethylpiperazino or morpholino, and

R⁸ represents hydrogen, methyl, ethyl, chlorine or phenyl,

wherein the alkyl radicals such as propyl, butyl, etc. can be branched.

Heterocyclic azo dyes which are also very particularly suitable according to the invention are those of the formula

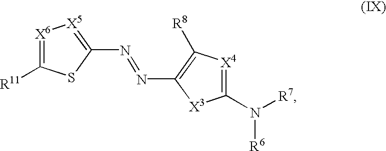

in which

X⁵ represents N,

X⁶ represents C—R¹²,

R¹¹ represents hydrogen, methyl, ethyl, propyl, butyl, methoxy, ethoxy, phenoxy, methylthio, ethylthio, propylthio, butylthio, dimethylamino, diethylamino, dipropylamino, dibutylamino, N-methyl-N-cyanoethylamino, N-methyl-N-methoxyethylamino, N-methyl-N-hydroxyethylamino, bis-(cyanoethyl)amino, bis-(methoxyethyl)amino, bis-(hydroxyethyl)amino, N-methyl-N-benzylamino, N-methyl-N-phenylamino, phenylamino, methoxyphenylamino, pyrrolidino, piperidino, N-methyl-, N-ethyl-, N-hydroxyethyl- or N-cyanoethylpiperazino or morpholino,

R¹² represents hydrogen, methyl or ethyl or

R¹¹;R¹² together represent a —CH═CH—CH═CH— bridge which can be substituted by methyl, chlorine, nitro or methoxy,

X³ represents O or S,

X⁴ represents N or CH,

NR⁶R⁷ represents dimethylamino, diethylamino, dipropylamino, dibutylamino, N-methyl-N-cyanoethylamino, N-methyl-N-methoxyethylamino, N-methyl-N-hydroxyethylamino, bis-(cyanoethyl)amino, bis-(methoxyethyl)amino, bis-(hydroxyethyl)amino, N-methyl-N-benzylamino, N-methyl-N-phenylamino, phenylamino, methoxyphenylamino, pyrrolidino, piperidino, N-methyl-, N-ethyl-, N-hydroxyethyl- or N-cyanoethylpiperazino or morpholino, and

R⁸ represents hydrogen, methyl, ethyl, chlorine or phenyl,

wherein the alkyl radicals such as propyl, butyl, etc. can be branched.

Heterocyclic azo dyes which are also very particularly suitable according to the invention are those of the formula

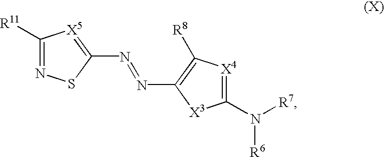

in which

X⁵ represents N,

R¹¹ represents hydrogen, methyl, ethyl or phenyl,

X³ represents O or S,

X⁴ represents N or CH,

NR⁶R⁷represents dimethylamino, diethylamino, dipropylamino, dibutylamino, N-methyl-N-cyanoethylamino, N-methyl-N-methoxyethylamino, N-methyl-N-hydroxyethylamino, bis-(cyanoethyl)amino, bis-(methoxyethyl)amino, bis-(hydroxyethyl)amino, N-methyl-N-benzylamino, N-methyl-N-phenylamino, phenylamino, methoxyphenylamino, pyrrolidino, piperidino, N-methyl-, N-ethyl-, N-hydroxyethyl- or N-cyanoethylpiperazino or morpholino, and

R⁸ represents hydrogen, methyl, ethyl, chlorine or phenyl,

wherein the alkyl radicals such as propyl, butyl etc. can be branched.

Heterocyclic azo dyes which are also very particularly suitable according to the invention are those of the formula

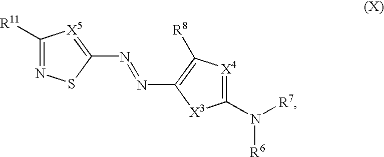

in which

X⁵ represents C—R¹²,

R¹¹ represents hydrogen, methyl, ethyl or phenyl,

R¹² represents hydrogen, cyano, nitro, methoxycarbonyl or ethoxycarbonyl or

R¹¹;R¹² together represent a —CH═CH—CH═CH— bridge, which can be substituted by methyl, methoxy, chlorine, cyano, nitro, methoxycarbonyl or ethoxycarbonyl or

X³ represents O or S,

X⁴ represents N or CH,

NR⁶R⁷ represents dimethylamino, diethylamino, dipropylamino, dibutylamino, N-methyl-N-cyanoethylamino, N-methyl-N-methoxyethylamino, N-methyl-N-hydroxyethylamino, bis-(cyanoethyl)amino, bis-(methoxyethyl)amino, bis-(hydroxyethyl)amino, N-methyl-N-benzylamino, N-methyl-N-phenylamino, phenylamino, methoxyphenylamino, pyrrolidino, piperidino, N-methyl-, N-ethyl-, N-hydroxyethyl- or N-cyanoethylpiperazino or morpholino, and

R⁸ represents hydrogen, methyl, ethyl, chlorine or phenyl,

wherein the alkyl radicals such as propyl, butyl, etc. can be branched.

Heterocyclic azo dyes which are also very particularly suitable according to the invention are those of the formula

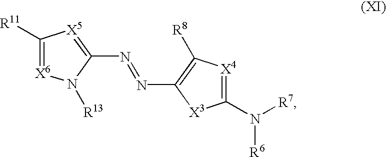

in which

X⁵ represents N,

X⁶ represents C—R²,

R¹¹ represents hydrogen, methyl, ethyl, methoxy, ethoxy, methylthio, amino, dimethylamino, diethylamino, formylamino, acetylamino, benzoylamino, pyrrolidino, piperidino, N-methyl-, N-ethyl-, N-hydroxyethyl- or N-cyanoethylpiperazino or morpholino,

R¹² represents hydrogen, methyl, ethyl, cyano, methoxycarbonyl, ethoxycarbonyl or phenyl,

R¹³ represents hydrogen, methyl, ethyl, propyl, butyl, cyclohexyl, benzyl or phenyl,

X³ represents O or S,

X⁴ represents N or CH,

NR⁶R⁷ represents dimethylamino, diethylamino, dipropylamino, dibutylamino, N-methyl-N-cyanoethylamino, N-methyl-N-methoxyethylamino, N-methyl-N-hydroxyethylamino, bis-(cyanoethyl)amino, bis-(methoxyethyl)amino, bis-(hydroxyethyl)amino, N-methyl-N-benzylamino, N-methyl-N-phenylamino, phenylamino, methoxyphenylamino, pyrrolidino, piperidino, N-methyl-, N-ethyl-, N-hydroxyethyl- or N-cyanoethylpiperazino or morpholino, and

R⁸ represents hydrogen, methyl, ethyl, chlorine or phenyl,

wherein the alkyl radicals such as propyl, butyl, etc. can be branched.

Heterocyclic azo dyes which are also very particularly suitable according to the invention are those of the formula

in which

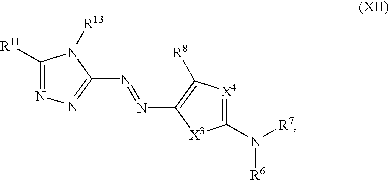

R¹¹ represents hydrogen, methyl, ethyl, methoxy, phenyl, amino, dimethylamino, acetylamino, pyrrolidino, piperidino, N-methyl-, N-ethyl-, N-hydroxyethyl- or N-cyanoethylpiperazino or morpholino,

R¹³ represents hydrogen, methyl, ethyl, propyl, butyl, cyclohexyl, benzyl or phenyl,

X³ represents O or S,

X⁴ represents N or CH,

NR⁶R⁷ represents dimethylamino, diethylamino, dipropylamino, dibutylamino, N-methyl-N-cyanoethylamino, N-methyl-N-methoxyethylamino, N-methyl-N-hydroxyethylamino, bis-(cyanoethyl)amino, bis-(methoxyethyl)amino, bis-(hydroxyethyl)amino, N-methyl-N-benzylamino, N-methyl-N-phenylamino, phenylamino, methoxyphenylamino, pyrrolidino, piperidino, N-methyl-, N-ethyl-, N-hydroxyethyl- or N-cyanoethylpiperazino or morpholino, and

R⁸ represents hydrogen, methyl, ethyl, chlorine or phenyl,

wherein the alkyl radicals such as propyl, butyl, etc. can be branched.

Heterocyclic azo dyes are in some cases known, for example from DE-OS 2 811 258, FR 2 394 587, DE-OS 4 343 454, EP—A 0 702 107, DE-OS 3 611 228, Am. Dyest. Rep. 1988, 77, 32.

The invention also relates to heterocyclic azo dyes of the formulae (X), (XI) or (XII), wherein the radicals X³ to X⁶, R⁶ to R⁸ and R¹¹ to R¹³ have the above-mentioned general, particularly preferred and very particularly preferred meanings.

The light-absorbing substances described guarantee sufficiently high reflectivity (>10%) of the optical data storage medium in the unrecorded state and sufficiently high absorption for the thermal degradation of the information layer upon spotwise illumination with focussed light, if the wavelength of the light is in the range from 360 to 460 nm and 600 to 680 nm. The contrast between the recorded and unrecorded areas of the data storage medium is effected by the change in reflectivity in terms of the amplitude as well as the phase of the incident light as a result of the changed optical properties of the information layer following thermal degradation.

The heterocyclic azo dyes are preferably applied to the optical data storage medium by spin-coating or vacuum coating by evaporation. The heterocyclic azo dyes can be mixed with other heterocyclic azo dyes or with other dyes having similar spectral properties. The information layer can contain additives in addition to the heterocyclic azo dyes, such as binders, wetting agents, stabilizers, diluents and sensitizers as well as other constituents.

In addition to the information layer, the optical data storage medium can contain other layers such as metal layers, dielectric layers and protective layers. Metals and dielectric layers are used, for example, for adjusting the reflectivity and the thermal balance. Depending on the laser wavelength, the metals can be gold, silver or aluminium, etc. Dielectric layers are, for example, silicon dioxide and silicon nitride. Protective layers are, for example, photocurable surface coatings, (pressure-sensitive) adhesive layers and protective films.

Preferred pressure-sensitive adhesive layers mainly consist of acrylic adhesives. Nitto Denko DA-8320 or DA-8310, which are disclosed in the patent JP-A 11-273147, can for example be used for this purpose.

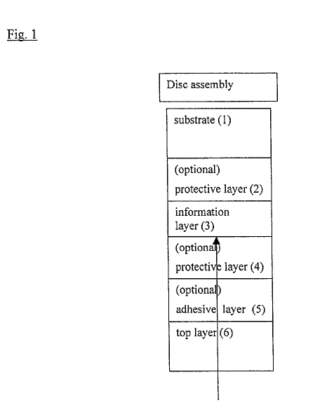

The optical data storage medium has, for example, the following layer assembly (cf. FIG. 1): a transparent substrate (1), optionally a protective layer (2), an information layer (3), optionally a protective layer (4), optionally an adhesive layer (5) and a top layer (6).

Preferably, the optical data storage medium assembly can contain:

a preferably transparent substrate (1), onto whose surface at least one photorecordable information layer (3), which can be recorded on using light, preferably laser light, optionally a protective layer (4), optionally an adhesive layer (5) and a transparent top layer (6) are applied;

a preferably transparent substrate (1), onto whose surface a protective layer (2), at least one information layer (3) which can be recorded on using light, preferably laser light, optionally an adhesive layer (5) and a transparent top layer (6) are applied;

a preferably transparent substrate (1), onto whose surface optionally a protective layer (2), at least one information layer (3) which can be recorded on using light, preferably laser light, optionally a protective layer (4), optionally an adhesive layer (5) and a transparent top layer (6) are applied;

a preferably transparent substrate (1), onto whose surface at least one information layer (3) which can be recorded on using light, preferably laser light, optionally an adhesive layer (5) and a transparent top layer (6) are applied.

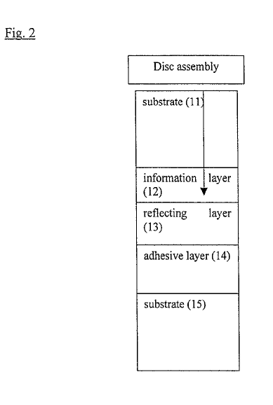

Alternatively, the optical data storage medium has for example the following layer assembly (cf. FIG. 2): a preferably transparent substrate (11), an information layer (12), optionally a reflecting layer (13), optionally an adhesive layer (14) and an additional, preferably transparent, substrate (15).

The invention also relates to optical data storage media according to the invention which are recorded on using blue or red light, and in particular laser light.

The following examples illustrate the subject matter of the invention:

### EXAMPLES

### Example 1

4 g of 2-amino-5-(diisopropylamino)-1,3,4-thiadiazole were dissolved in 40 ml of glacial acetic acid. 8 ml of 85% by weight phosphoric acid and 6 ml of 48% by weight sulphuric acid were added dropwise at 10° C. 6.8 g of nitrosylsulphuric acid (40% by weight in sulphuric acid) were then added dropwise at 5° C. over a period of 30 mins. After 4 h at 0-5° C. the nitrite excess was destroyed with amidosulphonic acid.

This diazotized product was added dropwise at 1 0° C. over a period of 1 hour to a solution of 2.6 g of 2-dimethylaminothiazole in 30 ml of glacial acetic acid, a pH of 3 being maintained with a 20% by weight aqueous soda solution. After stirring overnight at a pH of 3.5 the mixture was filtered off with suction and the residue was washed with water. The solid was stirred into 100 ml of water and the mixture was adjusted to a pH of 7.5, filtered off with suction once again and the residue was washed with water. After drying, the crude product was dissolved in 400 ml of tetrahydrofuran. By slowly adding 400 ml of water with stirring, the product was precipitated, filtered off with suction, washed with water and dried. 4.5 g (66% of theory) of a red powder of th formula

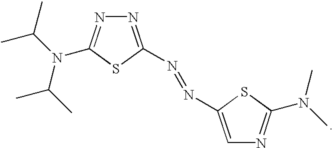

were obtained.

M.P. =232-233° C.

λₘₐₓ=496 nm

ε=44140 l/mol cm

λ_{1/2}-λ_{1/10} (long-wave slope)=22 nm

Δλ=═λ_{DMF}−λ_{dioxan}|=2 nm

Solubility: >2% in TFP (2,2,3,3-tetrafluoropropanol)

a glassy film

Heterocyclic azo dyes which are also suitable are listed in the following table:

| Ex. | 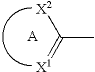 | K | λₘₐₓ/nm¹⁾ | ε/l/mol cm | λ_{1/2}-λ_{1/10}/nm²⁾ | λ_{1/2}-λ_{1/10}/nm³⁾ | Δλ⁴⁾/nm |
|---|---|---|---|---|---|---|---|
| 2 | 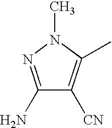 | 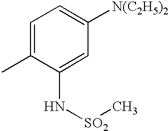 | 514⁵⁾ | 48250 | 63 | 19 | |
| 3 | 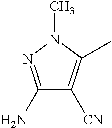 | 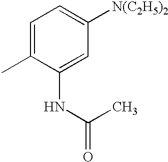 | 526⁶⁾ | 46500 | 67 | 20 | |
| 4 | 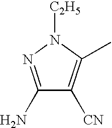 | 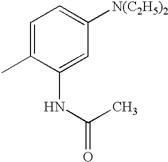 | 516 | 46000 | 66 | 17 | |
| 5 | 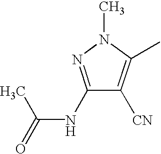 | 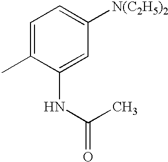 | 530⁶⁾ | 45100 | 57 | 18 | |
| 6 | 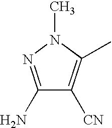 | 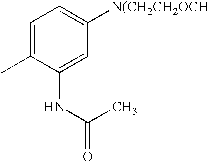 | 514 | 45915 | 64 | 15 | 7 |
| 7 | 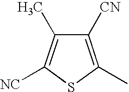 | 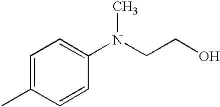 | 577⁶⁾ | 43950 | 61 | 39 | |
| 8 | 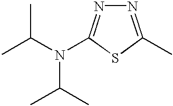 | 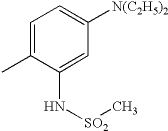 | 526 | 46115 | 64 | 19 | |
| 9 | 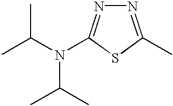 | 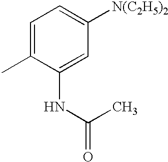 | 519 | 42100 | 77 | 23 | |
| 10 | 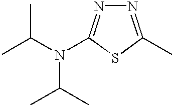 | 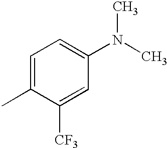 | 516⁶⁾ | 46900 | 65 | 17 | |
| 11 | 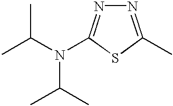 | 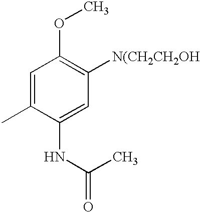 | 540⁵⁾ | 43840 | 105 | 21 | |
| 12 | 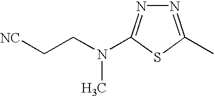 | 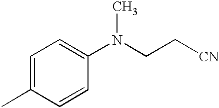 | 473 | 37555 | 40 | 16 | |
| 13 | 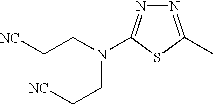 | 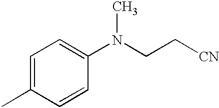 | 473 | 38120 | 41 | 18 | |
| 14 | 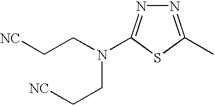 | 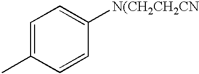 | 487 | 32750 | 44 | 18 | |
| 15 | 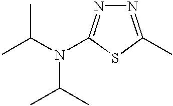 | 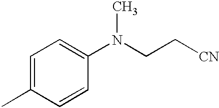 | 498⁶⁾ | | | | |
| 16 | 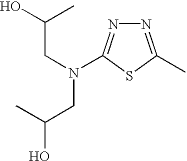 | 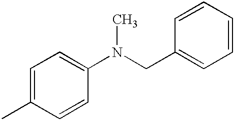 | 506⁶⁾ | | | | |
| 18 | 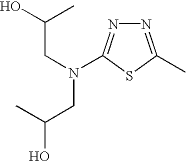 | 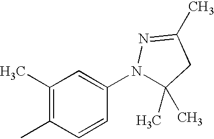 | | | | | |
| 19 | 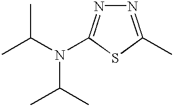 | 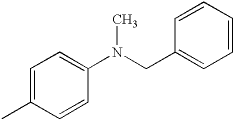 | 506⁶⁾ | | | | |
| 20 | 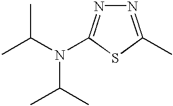 | 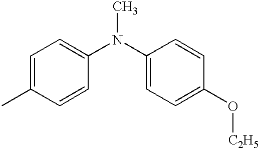 | | | | | |
| 21 | 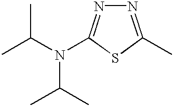 | 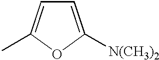 | | | | | |
| 22 | 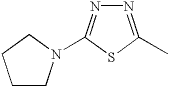 | 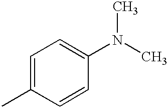 | | | | | |
| 23 | 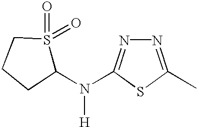 | 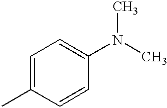 | | | | | |
| 24 | 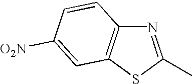 | 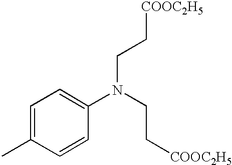 | 513 | 43880 | 61 | 25 | |
| 25 | 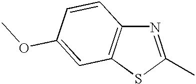 | 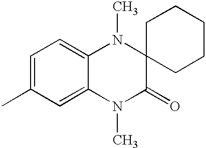 | | | | | |
| 26 | 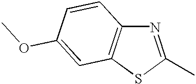 | 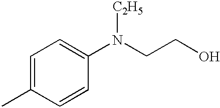 | | | | | |
| 27 | 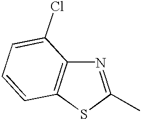 | 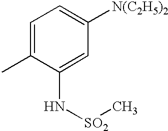 | | | | | |
| 28 | 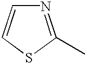 | 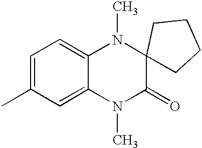 | | | | | |
| 29 | 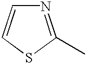 | 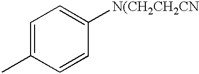 | | | | | |
| 30 | 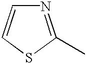 | 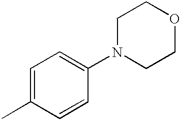 | | | | | |
| 31 | 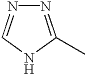 | 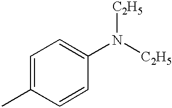 | | | | | |
| 32 | 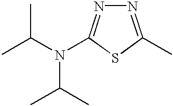 | 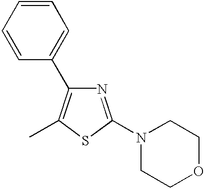 | 531 | 37000 | | 29 | 3 |
| 33 | 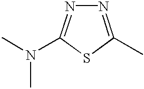 | 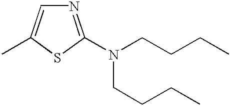 | 492 | 44530 | | 21 | 2 |
| 34 | 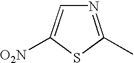 | 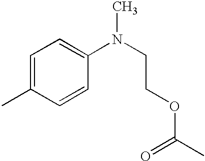 | 582⁶⁾ | | | | |
| 35 | 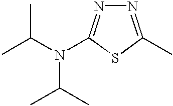 | 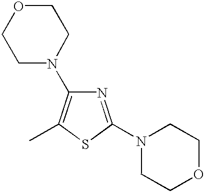 | | | | | |

¹⁾in dioxan, unless indicated otherwise.
²⁾on the short-wave slope
³⁾on the long-wave slope
⁴⁾Δλ = |λ_{DMF} − λ_{dioxan}|
⁵⁾in methanol/glacial acetic acid 9:1
⁶⁾in DMF

### Example 36

A 2% by weight solution of the dye of Example 11 in 2,2,3,3-tetrafluoropropanol was prepared at room temperature. This solution was applied by means of spin-coating to a pre-grooved polycarbonate substrate. The pre-grooved polycarbonate substrate was produced in the form of a disc by injection-moulding. The dimensions of the disc and the groove structure corresponded to those usually employed for CD-R's. The disc containing the dye layer as the information carrier was vapour-plated with 100 nm of silver. Then a UV-curable acrylic lacquer was applied by spin-coating and cured using a UV lamp. Using a dynamic recording test setup constructed on an optical bench and consisting of a diode laser (R =660 nm) for producing linearly polarized light, a polarization-sensitive beam splitter, a %/4-plate and a movably suspended collective lens with a numerical aperture NA of 0.6 (actuator lens) experiments on the recording (writing) and reading of data were carried out. The light reflected from the reflecting layer of the disc was coupled out of the beam path with the aid of the abovementioned polarization-sensitive beam splitter and focussed onto a four-quadrant detector through an astigmatic lens. At a linear velocity of V=2 m/s and a recording (writing) power of P_{w}=20 mW a signal-to-noise ratio of C/N=30 dB was measured. The recording power was applied as an oscillating pulse sequence, the disc being irradiated alternately for 500 ns with the abovementioned recording power PW and for 500 ns with the reading power Pᵣ=2 mW. The disc was irradiated with this oscillating pulse sequence until it had turned completely a single time. Then the marking produced was read with a reading power Pᵣ of 2 mW and the abovementioned signal-to-noise ratio C/N was determined.

1. An optical data storage medium containing a preferably transparent substrate which has optionally already been coated with one or more reflecting layers and onto whose surface a photorecordable information layer, optionally one or more reflecting layers and optionally a protective layer or an additional substrate or a top layer are applied, which data storage medium can be recorded on and read using blue or red light, preferably laser light, wherein the information layer contains a light-absorbing compound and optionally a binder, characterized in that at least one heterocyclic azo dye is used as the light-absorbing compound.

2. An optical data storage medium according to claim 1, characterized in that the heterocyclic azo dye corresponds to the formula (I) 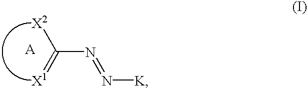
in which
K represents the radical of a coupling component of the formula 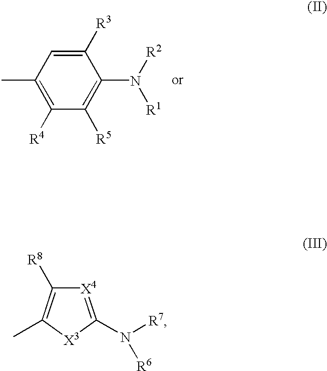
X¹ represents N or CH,
X² represents O, S, N—R⁹ or CH, but X¹ and X² may not simultaneously represent CH,
A together with X¹ and x² and the C-atom bound therebetween, represents a five- or six-membered aromatic or quasi-aromatic heterocyclic ring, which contains 1 to 4 hetero atoms and/or can be benzo- or naphtho-fused and/or substituted by non-ionic radicals,
X³ represents O or S,
X⁴ represents CR¹⁰ or N,
R¹, R², R⁶, R⁷ and R⁹ independently of one another represent hydrogen, C₁- to C₆-alkyl, C₅- to C₇-cycloalkyl, C₆- to C₁₀-aryl or C₇- to C₁₅-aralkyl or
NR¹R² and NR⁶R⁷ independently of one another represent pyrrolidino, morpholino, piperazino or piperidino,
R³ and R⁵ independently of one another represent hydrogen, C₁- to C₆-alkyl, C₁- to C₆-alkoxy or halogen or
R³;R² and R⁵;R¹ independently of one another form a two- or three-membered bridge which can contain O or N and can be substituted by non-ionic radicals,
R⁴ represents hydrogen, C₁- to C₆-alkyl, C₁- to C₆-alkoxy, halogen, C₁- to C₆-acylamino, C₁- to C₆-alkylsulphonylamino, C₆- to C₁₀-aryl-carbonylamino or C₆- to C₁₀-arylsulphonylamino,
R⁸ represents hydrogen, C₁- to C₆-alkyl, halogen, C₆- to C₁₀-aryl, bis-C₁- to C₆-dialkylamino, pyrrolidino, piperidino or morpholino and
R¹⁰ represents hydrogen, cyano, C₁- to C₆-alkyl, halogen or C₆- to C₁₀-aryl.

3. An optical data storage medium according to claim 2, characterized in that the radical of the formula (IV) 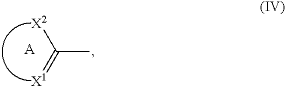
represents benzothiazol-2-yl, benzoxazol-2-yl, benzimidazol-2-yl, thiazol-2-yl, isothiazol-3-yl, isoxazol-3-yl, imidazol-2-yl, pyrazol-5-yl, 1,3,4-thiadiazol-2-yl, 1,2,4-thiadiazol-5-yl, 1,2,3-thiadiazol-5-yl, 1,3,4-oxadiazol-2-yl, 1,3,4-triazol-2-yl, thiophen-2-yl, benzothiophen-2-yl, 2- or 4-pyridyl, or 2- or 4-quinolyl, it being possible for these radicals each to be substituted by C₁- to C₆-alkyl, C₁- to C₆-alkoxy, fluorine, chlorine, bromine, iodine, cyano, nitro, C₁- to C₆-alkoxy-carbonyl, C₁- to C₆-alkylthio, C₁- to C₆-acylamino, C₆- to C₁₀-aryl, C₆-to C₁₀-aryloxy, C₆- to C₁₀-arylcarbonylamino, mono- or di-C, —to C₆-alkylamino, N-C₁- to C₆-alkyl-N-C₆- to C₁₀-arylamino, pyrrolidino, morpholino, piperazino or piperidino.

4. An optical data storage medium according to one or more of claims 1 to 3, characterized in that the heterocyclic azo dye corresponds to the formula (V) 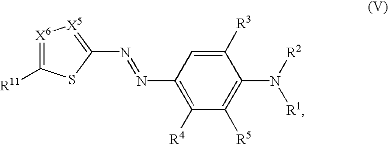
in which
X⁵ and X⁶ independently of one another represent C—R¹² or N,
R¹¹ represents hydrogen, C₁- to C₄-alkyl, C₁- to C₄-alkoxy, C₅- to C₆-cycloalkoxy, C₆- to C₁₀-aryloxy, C₁- to C₄-alkylthio, mono- or bis-C₁- to C₄-alkylamino, N-C₁- to C₄-alkyl-N-C₆- to C₁₀-arylamino, N-C₁- to C₄-alkyl-N-C₅- to C₆-cycloalkylamino, N-C₁- to C₄-alkyl-N-C₇- to C₁₂-aralkylamino, C₁- to C₄-alkanoylamino, C₆- to C₁₀-aroylamino, pyrrolidino, piperidino, piperazino or morpholino,
R¹² represents hydrogen, C₁- to C₄-alkyl, C₁- to C₄-alkoxy, cyano, C₁- to C₄-alkoxycarbonyl or C₆- to C₁₀-aryl, or if X⁶ represents C—R¹²,
R¹¹;R¹² together form a —CH═CH—CH═CH— bridge,
NR¹R²represents mono- or bis-Ci- to C₄-alkylamino, N-C₁- to C₄-alkyl-N—C₆- to C₁₀-arylamino, N-C₁- to C₄-alkyl-N-C₅- to C₆-cycloalkylamino, N-C₁- to C₄-alkyl-N-C₇- to C₁₂-aralkylamino, pyrrolidino, piperidino, piperazino or morpholino,
R³ represents hydrogen, C₁- to C₄-alkyl or C₁- to C₄-alkoxy or
R³; R¹ together represent a —CH₂—CH₂—, —CH₂—CH₂—CH₂—, —O—CH₂—CH₂— or —CH(CH₃)—CH₂—C(CH₃)₂— bridge,
R⁵ represents hydrogen or
R⁵; R² together represent a —CH₂—CH₂—, —CH₂—CH₂—CH₂—, —O—CH₂—CH₂— or —CH(CH₃)—CH₂—C(CH₃)₂— bridge and
R⁴ represents hydrogen, C₁- to C₄-alkyl, C₁- to C₄-alkoxy, chlorine, C₁- to C₄-alkanoylamino, N-C₁- to C₄-alkyl-N-C₁- to C₄-alkanoylamino, C₁-C to C₄-alkylsulphonylamino, N-C₁- to C₄-alkyl-N-C₁- to C₄-alkylsulphonylamino, C₆- to C₁₀-aroylamino or C₆- to C₁₀-aryl-sulphonylamino.

5. An optical data storage medium according to one or more of claims 1 to 3, characterized in that the heterocyclic azo dye corresponds to the formula (VI) 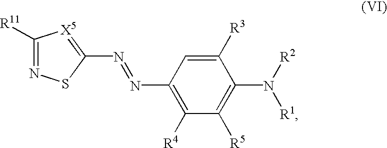
in which
X⁵ represents C—R¹² or N,
R¹¹ represents hydrogen, C₁- to C₄-alkyl, C₁- to C₄-alkoxy, C₅- to C₆-cycloalkoxy, C₆- to C₁₀-aryloxy, C₁- to C₄-alkylthio, mono- or bis-C₁- to C₄-alkylamino, N-C₁- to C₄-alkyl-N-C₆- to C₁₀-arylamino, N-C₁- to C₄-alkyl-N-C₅- to C₆-cycloalkylamino, N-C₁- to C₄-alkyl-N-C₇- to C₁₂-aralkylamino, C₁- to C₄-alkanoylamino, C₆- to C₁₀-aroylamino, pyrrolidino, piperidino, piperazino or morpholino,
R¹² represents hydrogen, C₁- to C₄-alkyl, C₁- to C₄-alkoxy, cyano, nitro, C₁- to C₄-alkoxycarbonyl or C₆- to C₁₀-aryl, or X⁵ represents C—R¹²,
R¹¹;R¹² together form a —CH═CH—CH═CH— bridge,
NR¹R² represents mono- or bis-C₁- to C₄-alkylamino, N-C₁- to C₄-alkyl-N—C₆- to C₁₀-arylamino, N-C₁- to C₄-Alkyl-N-C₅- to C₆-cycloalkylamino, N-C₁- to C₄-alkyl-N-C₇- to C₁₂-aralkylamino, pyrrolidino, piperidino, piperazino or morpholino,
R³ represents hydrogen, C₁- to C₄-alkyl or C₁- to C₄-alkoxy or
R³; R¹ together represent a —CH₂—CH₂—, —CH₂—CH₂—CH₂—, —O—CH₂—CH₂— or —CH(CH₃)—CH₂—C(CH₁₃)₂— bridge,
R⁵ represents hydrogen or
R³; R² together represent a —CH₂—CH₂—, —CH₂—CH₂—CH₂—, —O—CH₂—CH₂— or —CH(CH₃)—CH₂—C(CH₃)₂— bridge and
R⁴ represents hydrogen, C₁- to C₄-alkyl, C₁- to C₄-alkoxy, chlorine, C₁- to C₄-alkanoylamino, N-C₁- to C₄-alkyl-N-C₁- to C₄-alkanoylamino, C₁- to C₄-alkylsulphonylamino, N-C₁- to C₄-alkyl-N-C₁- to C₄-alkylsulphonylamino, C₆- to C₁₀-aroylamino or C₆- to C₁₀-aryl-sulphonylamino.

6. An optical data storage medium according to one or more of claims 1 to 3, characterized in that the heterocyclic azo dye corresponds to the formula (VII) 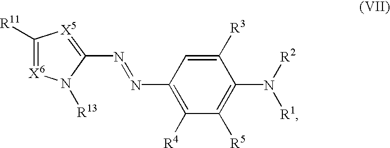
in which
X⁵ and x⁶ independently of one another represent C—R¹² or N,
R¹¹ represents hydrogen, C₁- to C₄-alkyl, C₁- to C₄-alkoxy, C₅- to C₆-cycloalkoxy, C₆- to C₁₀-aryloxy, C₁- to C₄-alkylthio, mono- or bis-C₁- to C₄-alkylamino, N-C₁- to C₄-alkyl-N-C₆- to C₁₀-arylamino, N-C₁- to C₄-alkyl-N-C₅- to C₆-cycloalkylamino, N-C₁- to C₄-alkyl-N-C₇- to C₁₂-aralkylamino, C₁- to C₄-alkanoylamino, C₆- to C₁₀-aroylamino, pyrrolidino, piperidino, piperazino or morpholino,
R¹² represents hydrogen, C₁- to C₄-alkyl, C₁- to C₄-alkoxy, cyano, C₁- to C₄-alkoxycarbonyl or C₆- to C₁₀-aryl or, if X⁶ represents C—R¹²,
R¹¹;R¹² together form a —CH═CH—CH═CH— bridge,
R¹³ represents hydrogen, C₁- to C₄-alkyl, C₅- to C₆-cycloalkyl, C₇ to C₁₂-aralkyl or C₆- to C₁₀-aryl,
NR¹R² represents mono- or bis-C₁- to C₄-alkylamino, N-C₁- to C₄-alkyl-N—C₆- to C₁₀-arylamino, N-C₁- to C₄-alkyl-N-C₅- to C₆-cycloalkylamino, N-C₁- to C₄-alkyl-N-C₇- to C₁₂-aralkylamino, pyrrolidino, piperidino, piperazino or morpholino,
R³ represents hydrogen, C₁- to C₄-alkyl or C₁- to C₄-alkoxy or
R³; R¹ together represent a —CH₂—CH₂—, —CH₂—CH₂—CH₂—, —O—CH₂—CH₂— or —CH(CH₃)—CH₂—C(CH₃)₂— bridge,
R⁵ represents hydrogen or
R⁵; R² together represent a —CH₂—CH₂—, —CH₂—CH₂—CH₂—, —O—CH₂—CH₂— or —CH(CH₃)—CH₂—C(CH₃)₂— bridge and
R⁴ represent hydrogen, C₁- to C₄-alkyl, C₁- to C₄-alkoxy, chlorine, C₁- to C₄-alkanoylamino, N-C₁- to C₄-Alkyl-N-C₁- to C₄-alkanoylamino, C₁- to C₄-alkylsulphonylamino, N-C₁- to C₄-alkyl-N-C₁- to C₄-alkylsulphonylamino, C₆- to C₁₀-aroylamino or C₆- to C₁₀-aryl-sulphonylamino.

7. An optical data storage medium according to one or more of claims 1 to 3, characterized in that the heterocyclic azo dye corresponds to the formula (VIII) 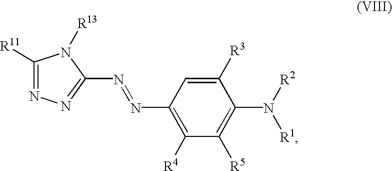
in which
R¹¹ represents hydrogen, C₁- to C₄-alkyl, C₁- to C₄-alkoxy, C₅- to C₆-cycloalkoxy, C₆- to C₁₀-aryloxy, C₁- to C₄-alkylthio, mono- or bis-C₁- to C₄-alkylamino, N-C₁- to C₄-alkyl-N-C₆- to C₁₀-arylamino, N-C₁- to C₄-alkyl-N-C₅- to C₆-cycloalkylamino, N-C₁- to C₄-alkyl-N-C₇- to C₁₂-aralkylamino, C₁- to C₄-alkanoylamino, C₆- to C₁₀-aroylamino, pyrrolidino, piperidino, piperazino or morpholino,
R¹³ represents hydrogen, C₁- to C₄-alkyl, C₅- to C₆-cycloalkyl, C₇ to C₁₂-aralkyl or C₆- to C₁₀-aryl,
NR¹R² represents mono- or bis-C₁- to C₄-alkylamino, N-C₁- to C₄-alkyl-N-C- to C₁₀-arylamino, N-C₁- to C₄-alkyl-N-C₅- to C₆-cycloalkylamino, N-C₁- to C₄-alkyl-N-C₇- to C₁₂-aralkylamino, pyrrolidino, piperidino, piperazino or morpholino,
R³ represents hydrogen, C₁- to C₄-alkyl or C₁- to C₄-alkoxy or
R³; R¹ together represent a —CH₂—CH₂—, —CH₂—CH₂—CH₂—, —O—CH₂—CH₂— or —CH(CH₃)—CH₂—C(CH₃)₂— bridge,
R⁵ represents hydrogen or
R⁵; R² together represent a —CH₂—CH₂—, —CH₂—CH₂—CH₂—, —O—CH₂—CH₂— or —CH(CH₃)—CH₂—C(CH₃)₂— bridge and
R⁴ represents hydrogen, C₁- to C₄-alkyl, C₁- to C₄-alkoxy, chlorine, C₁- to C₄-alkanoylamino, N-C₁- to C₄-alkyl-N-C₁- to C₄-alkanoylamino, C₁- to C₄-alkylsulphonylamino, N-C₁- to C₄-alkyl-N-C₁- to C₄-alkylsulphonylamino, C₆- to C₁₀-aroylamino or C₆- to C₁₀-aryl-sulphonylamino.

8. An optical data storage medium according to one or more of claims 1 to 3, characterized in that the heterocyclic azo dye corresponds to the formula (IX) 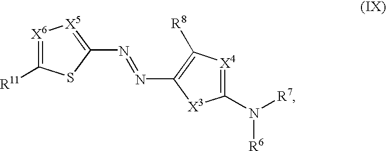
in which
X⁵ and X⁶ independently of one another represent C—R¹² or N,
R¹¹ represents hydrogen, C₁- to C₄-alkyl, C₁- to C₄-alkoxy, C₅- to C₆-cycloalkoxy, C₆- to C₁₀-aryloxy, C₁- to C₄-alkylthio, mono- or bis-C₁- to C₄-alkylamino, N-C₁- to C₄-alkyl-N-C₆- to C₁₀-arylamino, N-C₁- to C₄-alkyl-N-C₅- to C₆-cycloalkylamino, N-C₁- to C₄-alkyl-N-C₇- to C₁₂-aralkylamino, C₁- to C₄-alkanoylamino, C₆- to C₁₀-aroylamino, pyrrolidino, piperidino, piperazino or morpholino,
R¹² represents hydrogen, C₁- to C₄-alkyl, C₁- to C₄-alkoxy, cyano, C₁- to C₄-alkoxycarbonyl or C₆- to C₁₀-aryl or if X⁶ represents C—R¹²,
R¹¹;R² together form a —CH═CH—CH═CH— bridge,
X³ represents O or S,
X⁴ represents CH or N,
NR⁶R⁷ represents mono- or bis-C₁- to C₄-alkylamino, N-C₁- to C₄-alkyl-N—C₆- to C₁₀-arylamino, N-C₅- to C₄-alkyl-N-C₅- to C₆-cycloalkylamino,
N-C₁- to C₄-alkyl-N-C₇- to C₁₂-aralkylamino, pyrrolidino, piperidino, piperazino or morpholino,
R⁸ represents hydrogen, C₁- to C₄-alkyl, chlorine, C₆- to C₁₀-aryl, bis-C₁- to C₄-dialkylamino, pyrrolidino, piperidino or morpholino.

9. An optical data storage medium according to one or more of claims 1 to 3, characterized in that the heterocyclic azo dye corresponds to the formula (X) 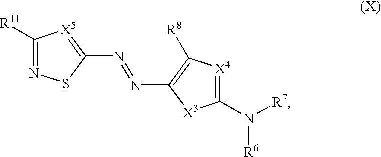
in which
X⁵ represents C—R² or N,
R¹¹ represents hydrogen, C₁- to C₄-alkyl, C₁- to C₄-alkoxy, C₅- to C₆-cycloalkoxy, C₆- to C₁₀-aryloxy, C₁- to C₄-alkylthio, mono- or bis-C₁- to C₄-alkylamino, N-C₁- to C₄-alkyl-N-C₆- to C₁₀-arylamino, N-C₁- to C₄-alkyl-N-C₅- to C₆-cycloalkylamino, N-C₁- to C₄-alkyl-N-C₇- to C₁₂-aralkylamino, C₁- to C₄-alkanoylamino, C₆- to C₁₀-aroylamino, pyrrolidino, piperidino, piperazino or morpholino,
R¹² represents hydrogen, C₁- to C₄-alkyl, C₁- to C₄-alkoxy, cyano, nitro, C₁- to C₄-alkoxycarbonyl or C₆- to C₁₀-aryl, or if X⁵ represents C—R¹²,
R¹¹;R¹² together form a —CH═CH—CH═CH— bridge,
X³ represents O or S,
X⁴ represents CH or N,
NR⁶R⁷ represents mono- or bis-C₁- to C₄-alkylamino, N-C₁- to C₄-alkyl-N-₆- to C₁₀-arylamino, N-C₁- to C₄-alkyl-N-C₅- to C₆-cycloalkylamino, N-C₁- to C₄-alkyl-N-C₇- to C₁₂-aralkylamino, pyrrolidino, piperidino, piperazino or morpholino,
R⁸ represents hydrogen, C₁- to C₄-alkyl, chlorine, C₆- to C₁₀-aryl, bis-C₁- to C₄-dialkylamino, pyrrolidino, piperidino or morpholino.

10. An optical data storage medium according to one or more of claims 1 to 3, characterized in that the heterocyclic azo dye corresponds to the formula (XI) 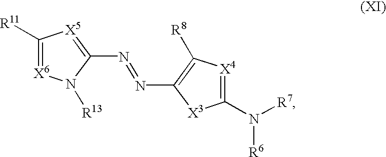
in which
X⁵ and X⁶ independently of one another represent C—R¹² or N, R¹¹ represents hydrogen, C₁- to C₄-alkyl, C₁- to C₄-alkoxy, C₅- to C₆-cycloalkoxy, C₆- to C₁₀-aryloxy, C₁- to C₄-alkylthio, mono- or bis-C₁- to C₄-alkylamino, N-C₁- to C₄-alkyl-N-C₆- to C₁₀-arylamino, N-C₁- to C₄-alkyl-N-C₅- to C₆-cycloalkylamino, N-C₁- to C₄-alkyl-N-C₇- to C₁₂-aralkylamino, C₁- to C₄-alkanoylamino, C₆- to C₁₀-aroylamino, pyrrolidino, piperidino, piperazino or morpholino,
R¹² represents hydrogen, C₁- to C₄-alkyl, C₁- to C₄-alkoxy, cyano, C₁- to C₄-alkoxycarbonyl or C₆- to C₁₀-aryl, or if X⁶ represents C—R¹²,
R¹¹;R¹² together form a —CH═CH—CH═CH— bridge, R¹³ represents hydrogen, C₁- to C₄-alkyl, C₅- to C₆-cycloalkyl, C₇- to C₁₂-aralkyl or C₆- to C₁₀-aryl,
X³ represents O or S,
X⁴ represents CH or N,
NR⁶R⁷ represents mono- or bis-C₁- to C₄-alkylamino, N-C₁- to C₄-alkyl-N-C₆- to C₁₀-arylamino, N-C₁- to C₄-alkyl-N-C₅- to C₆-cycloalkylamino, N-C₁- to C₄-alkyl-N-C₇- to C₁₂-aralkylamino, pyrrolidino, piperidino, piperazino or morpholino,
R⁸ represents hydrogen, C₁- to C₄-alkyl, chlorine, C₆- to C₁₀-aryl, bis-C₁- to C₄-dialkylamino, pyrrolidino, piperidino or morpholino.

11. An optical data storage medium according to one or more of claims 1 to 3, characterized in that the heterocyclic azo dye corresponds to the formula (XII) 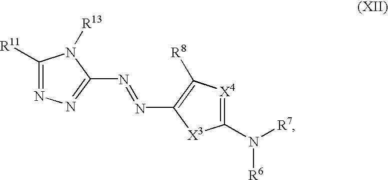
in which
R¹ represents hydrogen, C₁- to C₄-alkyl, C₁- to C₄-alkoxy, C₅- to C₆-cycloalkoxy, C₆- to C₁₀-aryloxy, C₁- to C₄-alkylthio, mono- or bis-C₁- to C₄-alkylamino, N-C₁- to C₄-alkyl-N-C₆- to C₁₀-arylamino, N-C₁- to C₄-alkyl-N-C₅- to C₆-cycloalkylamino, N-C₁- to C₄-alkyl-N-C₇- to C₁₂-aralkylamino, C₁- to C₄-alkanoylamino, C₆- to C₁₀-aroylamino, pyrrolidino, piperidino, piperazino or morpholino,
R¹³ represents hydrogen, C₁- to C₄-alkyl, C₅- to C₆-cycloalkyl, C₇- to C₁₂-aralkyl or C₆- to C₁₀-aryl,
X³ represents O or S,
X⁴ represents CH or N,
NR⁶R⁷ represents mono- or bis-C₁- to C₄-alkylamino, N-C₁- to C₄-alkyl-N-C₆- to C₁₀-arylamino, N-C₁- to C₄-alkyl-N-C₅- to C₆-cycloalkylamino, N-C₁- to C₄-alkyl-N-C₇- to C₁₂-aralkylamino, pyrrolidino, piperidino, piperazino or morpholino,
R⁸ represents hydrogen, C₁- to C₄-alkyl, chlorine, C₆- to C₁₀-aryl, bis-C₁- to C₄-dialkylamino, pyrrolidino, piperidino or morpholino.

12. The use of heterocyclic azo dyes in the information layer of recordable optical data storage media, wherein the heterocyclic azo dye has an absorption maximum λₘₐₓ₂ in the range from 420 to 650 nm.

13. The use of heterocyclic azo dyes in the information layer of recordable optical data storage media, wherein the data storage media are recorded on and read using a blue laser light.

14. A process for producing the optical data storage media according to claim 1, which is characterized in that a preferably transparent substrate, which has optionally already been coated with a reflecting layer, is coated with the heterocyclic azo dyes, optionally in combination with suitable binders and additives and optionally suitable solvents, and is optionally provided with a reflecting layer, additional intermediate layers and optionally a protective layer or an additional substrate or a top layer.

15. Optical data storage media according to claim 1 which have been recorded on using blue or red, in particular blue light, and especially blue laser light.

16. Heterocyclic azo dyes of the formula (X), (XI) or (XII) 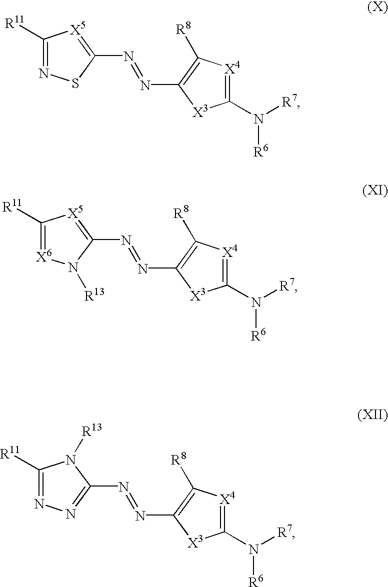
in which the radicals X³ to X⁶, R⁶ to R⁸ and R¹¹ to R¹³ have the meanings indicated in claims 9, 10 and 11.
